(19) United States
(12) Patent Application Publication
(10) Pub. No.: US 2007/0117949 A1
(43) Pub. Date: May 24, 2007

(54) Spandex from poly(tetramethylene-co-ethyleneether) glycols having low ethyleneether content

(76) Inventors: Charles F. Palmer JR., Waynesboro, VA (US); Gary A. Lodoen, Waynesboro, VA (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(21) Appl. No.: 11/429,754

(22) Filed: May 6, 2006

Related U.S. Application Data
(60) Provisional application No. 60/738,683, filed on Nov. 22, 2005.

(51) Int. Cl. C08G 18/00

(52) U.S. Cl. 528/44

(57) ABSTRACT

The invention provides a polyurethaneurea composition comprising at least one diisocyanate compound and a poly(tetramethylene-co-ethyleneether)glycol comprising constituent units derived by copolymerizing tetrahydrofuran and ethylene oxide, wherein the portion of the units derived from the ethylene oxide is present in the poly(tetramethylene-co-ethyleneether)glycol at less than about 15 mole percent. The invention further relates to the use of such low ethyleneether content poly(tetramethylene-co-ethyleneether)glycols in spandex compositions. The invention also relates to new polyurethane compositions comprising poly(tetramethylene-co-ethyleneether)glycols with such low ethyleneether content, and their use in spandex.

### CROSS-REFERENCE TO RELATED APPLICATIONS

This application claims benefit of priority from Provisional Application No. 60/738,683, filed Nov. 22, 2005. This application hereby incorporates by reference Provisional Application No. 60/738,683 in its entirety. This application relates to commonly-assigned applications filed concurrently on May 8, 2006 as Attorney Dockets LP5315 US NA, LP5720 US NA, LP5726 US NA, and LP5975 US NA.

### BACKGROUND OF THE INVENTION

1. Field of the Invention

This invention relates to new polyurethaneurea compositions comprising poly(tetramethylene-co-ethyleneether)glycols comprising constituent units derived by copolymerizing tetrahydrofuran and ethylene oxide, wherein the portion of the units derived from ethylene oxide is present in the poly(tetramethylene-co-ethyleneether)glycol at less than about 15 mole percent, at least one diisocyanate, at least one chain extender, and at least one chain terminator. The invention further relates to the use of poly(tetramethylene-co-ethyleneether)glycols having such low ethyleneether content as the soft segment base material in spandex compositions. The invention also relates to new polyurethane compositions comprising poly(tetramethylene-co-ethyleneether)glycols having such low ethyleneether content, and their use in spandex.

2. Description of the Related Art

Poly(tetramethylene ether)glycols, also known as polytetrahydrofuran or homopolymers of tetrahydrofuran (THF, oxolane) are well known for their use in soft segments in polyurethaneureas. Poly(tetramethylene ether)glycols impart superior dynamic properties to polyurethaneurea elastomers and fibers. They possess very low glass transition temperatures, but have crystalline melt temperatures above room temperature. Thus, they are waxy solids at ambient temperatures and need to be kept at elevated temperatures to prevent solidification.

Copolymerization with a cyclic ether has been used to reduce the crystallinity of the polytetramethylene ether chains. This lowers the polymer melt temperature of the copolyether glycol and at the same time improves certain dynamic properties of the polyurethaneurea that contains such a copolymer as a soft segment. Among the comonomers used for this purpose is ethylene oxide, which can lower the copolymer melt temperature to below ambient, depending on the comonomer content. Use of poly(tetramethylene-co-ethyleneether)glycols may also improve certain dynamic properties of polyurethaneureas, such as tenacity, elongation at break and low temperature performance, which is desirable for some end uses.

Poly(tetramethylene-co-ethyleneether)glycols are known in the art. Their preparation is described in U.S. Pat. Nos. 4,139,567 and 4,153,786. Such copolymers can be prepared by any of the known methods of cyclic ether polymerization, such as those described in “Polytetrahydrofuran” by P. Dreyfuss (Gordon & Breach, N.Y. 1982), for example. Such polymerization methods include catalysis by strong proton or Lewis acids, heteropoly acids, and perfluorosulfonic acids or acid resins. In some instances it may be advantageous to use a polymerization promoter, such as a carboxylic acid anhydride, as described in U.S. Pat. No.4,163,115. In these cases, the primary polymer products are diesters, which then need to be hydrolyzed in a subsequent step to obtain the desired polymeric glycols.

U.S. Pat. No. 5,684,179 to Dorai discloses the preparation of diesters of polytetramethylene ethers from the polymerization of THF with one or more comonomers. While Dorai includes 3-methyl THF, ethylene oxide, propylene oxide, etc., it does not describe a poly(tetramethylene-co-ethyleneether)glycol having less than about 15 mole percent ethyleneether content.

Spandex based on poly(tetramethylene-co-ethyleneether)glycols is also known in the art. However, most of these spandex compositions are based on poly(tetramethylene-co-ethyleneether)glycols with higher levels of ethyleneether content, i.e., greater than 30 mole percent. For example, U.S. Pat. No. 4,224,432 to Pechhold et al. discloses the use of poly(tetramethylene-co-ethyleneether)glycols with low cyclic ether content to prepare spandex and other polyurethaneureas. Pechhold teaches that ethyleneether levels above 30 percent are preferred.

U.S. Pat. No. 4,658,065 to Aoshima et al. discloses the preparation of several THF copolyethers via the reaction of THF and polyhydric alcohols using heteropolyacid catalysts. Aoshima also discloses that copolymerizable cyclic ethers, such as ethylene oxide, may be included with the THF in the polymerization process. Aoshima discloses that when the content of ethyleneether in a poly(tetramethylene-co-ethyleneether)glycol is less than about 0.5 percent, the physical properties approach those of poly(tetramethylene ether)glycol. Aoshima also discloses the use of THF copolyether glycols as starting materials for polyurethane and spandex, but provides no examples of low ethyleneether-content poly(tetramethylene-co-ethyleneether)s in polyurethanes or polyurethaneureas. The only examples of poly(tetramethylene-co-ethyleneethers) in spandex polyurethane disclosed were stated to be useful for improved low temperature properties.

U.S. Pat No. 3,425,999 to Axelrood et al. discloses the preparation of polyether urethaneureas from poly(tetramethylene-co-ethyleneether)glycols for use in oil resistance and good low temperature performance. The poly(tetramethylene-co-ethyleneether)glycols have ethyleneether content ranging from 20 to 60 percent by weight (equivalent to 29 to 71 mole percent). Axelrood does not disclose the use of these urethaneureas in spandex.

U.S. Pat. No. 6,639,041 to Nishikawa et al. discloses fibers having good elasticity at low temperature that contain polyurethaneureas prepared from polyols containing copolyethers of THF, ethylene oxide (15 to 37 mole percent), and/or propylene oxide, diisocyanates, and diamines and polymers solvated in organic solvents. Nishikawa teaches that these compositions have improved low temperature performance over standard homopolymer spandexes. Nishikawa discloses spandex based on a poly(tetramethylene-co-ethyleneether)glycol with 10 percent ethyleneether content, but merely as a comparison (Comparison Example 1). This example has a set of 31 percent at −5° C. and thus Nishikawa teaches that the spandex of the invention has desirably lower low-temperature set.

### SUMMARY OF THE INVENTION

The present invention relates to spandex comprising a polyurethane or polyurethaneurea reaction product of: (a) a poly(tetramethylene-co-ethyleneether)glycol comprising constituent units derived by copolymerizing tetrahydrofuran and ethylene oxide wherein the portion of the units derived from ethylene oxide is present in the poly(tetramethylene-co-ethyleneether)glycol at less than about 15 mole percent, (b) at least one diisocyanate, (c) at least one diamine or diol chain extender, and (d) at least one chain terminator.

The present invention also relates to a process for preparing the above spandex comprising: (a) contacting a poly(tetramethylene-co-ethyleneether)glycol comprising constituent units derived by copolymerizing tetrahydrofuran and ethylene oxide wherein the portion of the units derived from ethylene oxide is present in the poly(tetramethylene-co-ethyleneether)glycol at less than about 15 mole percent with at least one diisocyanate to form a capped glycol, (b) optionally adding a solvent to the product of (a), (c) contacting the product of (b) with at least one diamine or diol chain extender and at least one chain terminator, and (d) spinning the product of (c) to form spandex.

### DETAILED DESCRIPTION OF THE INVENTION

New spandex compositions are prepared from poly(tetramethylene-co-ethyleneether)glycols with low ethyleneether content, i.e., less than about 15 mole percent, a diisocyanate such as 1-isocyanato-4-[(4-isocyanato-phenyl)methyl]benzene, a chain extender such as an ethylene diamine, and a chain terminator such as diethylamine. Optionally, other diisocyanates, chain terminators, and chain extenders and coextenders may be used. For the purposes of this application, low-ethyleneether-containing poly(tetramethylene-co-ethyleneether)glycols are defined as those containing from about 1 to less than about 15 mole percent repeat units derived from ethylene oxide.

The segmented polyurethanes or polyurethaneureas of this invention are made from a poly(tetramethylene-co-ethyleneether)glycol and, optionally, a polymeric glycol, at least one diisocyanate, and a difunctional chain extender. Poly(tetramethylene-co-ethyleneether)glycols are of value in forming the “soft segments” of the polyurethanes or polyurethaneureas used in making spandex. The poly(tetramethylene-co-ethyleneether)glycol or glycol mixture is first reacted with at least one diisocyanate to form an NCO-terminated prepolymer (a “capped glycol”), which is then dissolved in a suitable solvent, such as dimethylacetamide, dimethylformamide, or N-methylpyrrolidone, and then reacted with a difunctional chain extender. Polyurethanes are formed when the chain extenders are diols. Polyurethaneureas, a sub-class of polyurethanes, are formed when the chain extenders are diamines. In the preparation of a polyurethaneurea polymer which can be spun into spandex, the poly(tetramethylene-co-ethyleneether)glycol is extended by sequential reaction of the hydroxy end groups with diisocyanates and diamines. In each case, the poly(tetramethylene-co-ethyleneether)glycol must undergo chain extension to provide a polymer with the necessary properties, including viscosity. If desired, dibutyltin dilaurate, stannous octoate, mineral acids, tertiary amines such as triethylamine, N,N′-dimethylpiperazine, and the like, and other known catalysts can be used to assist in the capping step.

The poly(tetramethylene-co-ethyleneether)glycols used in making the polyurethanes and polyurethaneureas of the present invention can be made by the method disclosed in U.S. Pat. No. 4,139,567 to Pruckmayr using a solid perfluorosulfonic acid resin catalyst. Alternatively, any other acidic cyclic ether polymerization catalyst may be used to produce these poly(tetramethylene-co-ethyleneether)glycols, for example, heteropoly acids. The heteropoly acids and their salts useful in the practice of this invention can be, for example, those catalysts used in the polymerization and copolymerization of cyclic ethers as described in U.S. Pat. No. 4,658,065 to Aoshima et al. These polymerization methods may include the use of additional promoters, such as acetic anhydride, or may include the use of chain terminator molecules to regulate molecular weight.

If the amount of ethyleneether in the poly(tetramethylene-co-ethyleneether)glycol is maintained at less than about 15 mole percent, the physical properties, especially the melting point, of the poly(tetramethylene-co-ethyleneether)glycol are essentially the same as those of poly(tetramethylene ether)glycols having the same or similar molecular weight. Similarly, the physical properties of spandex based on low ethyleneether containing poly(tetramethylene-co-ethyleneether)glycols are essentially the same as poly(tetramethylene ether)glycol-based spandex. Alternatively, the use of poly(tetramethylene-co-ethyleneether)glycols with higher ethyleneether content result in a spandex (or polyurethane) with markedly different physical properties than those based on poly(tetramethylene ether)glycols having the same molecular weight. Some of the spandex properties such as elongation, load power, unload power at high elongations, e.g., TM2, etc. and low temperature performance improve, but some properties worsen.

The poly(tetramethylene-co-ethyleneether)glycols of the present invention can comprise constituent units derived by copolymerizing tetiahydrofuran and ethylene oxide, wherein the percentage of ethylene ether moieties is from less than about 15 mole percent, or from about 5 to less than about 15 mole percent, or from about 10 to less than about 15 mole percent. Optionally, the poly(tetramethylene-co-ethyleneether)glycols of the present invention can comprise constituent units derived by copolymerizing tetrahydrofliran and ethylene oxide, wherein the percentage of ethylene ether moieties is from less than about 14 mole percent, or from about 5 to about 14 mole percent, or from about 10 to about 14 mole percent. The percentage of units derived from ethylene oxide present in the glycol is equivalent to the percent of ethyleneether moieties present in the glycol.

Poly(tetramethylene-co-ethylene ether)glycols used in making the polyurethanes or polyurethaneureas of the present invention can have an average molecular weight of about 650 Dalton to about 4000 Dalton. Higher poly(tetramethylene-co-ethyleneether)glycol molecular weight can be advantageous for selected physical properties, such as elongation.

The poly(tetramethylene-co-ethyleneether)glycols used in making the polyurethanes or polyurethaneureas of the present invention can include small amounts of units derived from chain terminator diol molecules, especially non-cyclizing diols. Non-cyclizing diols are defined as di-alcohols that will not readily cyclize to form a cyclic ether under the reaction conditions. These non-cyclizing diols can include ethylene glycol, 1,2-propylene glycol, 1,3-propylene glycol, 1,4-butynediol, and water.

Poly(tetramethylene-co-ethyleneether)glycols which optionally comprise at least one additional component, such as for example 3-methyltetrahydrofuran, the ether derived from 1,3-propanediol, or other diols incorporated in small amounts as molecular weight control agents, can also be used in making the polyurethanes and polyurethaneureas of the present invention and are included in the meaning of the term “poly(tetramethylene-co-ethyleneether) or poly(tetramethylene-co-ethyleneether)glycol.” The at least one additional component may be a comonomer of the polymeric glycol or it may be another material that is blended with the poly(tetramethylene-co-ethyleneether)glycol. The at least one additional component may be present to the extent that it does not detract from the beneficial aspects of the invention.

Diisocyanates that can be used include, but are not limited to, 1-isocyanato-4-[(4-isocyanatophenyl)methyl]benzene, 1-isocyanato-2-[(4-cyanatophenyl)methyl]benzene, bis(4-isocyanatocyclohexyl)methane, 5-isocyanato-1-(isocyanatomethyl)-1,3,3-trimethylcyclohexane, 1,3-diisocyanato-4-methyl-benzene, 2,2′-toluenediisocyanate, 2,4′-toluenediisocyanate, and mixtures thereof. The preferred diisocyanates are 1-isocyanato-4-[(4-isocyanatophenyl)methyl]benzene, 1-isocyanato-2-[(4-cyanatophenyl)methyl]benzene, and mixtures thereof. A particularly preferred diisocyanate is 1-isocyanato-4-[(4-isocyanatophenyl)methyl]benzene.

When a polyurethane is desired, the chain extender is a diol. Examples of such diols that may be used include, but are not limited to, ethylene glycol, 1,3-propanediol, 1,2-propylene glycol, 3-methyl-1,5-pentanediol, 2,2-dimethyl-1,3-trimethylene diol, 2,2,4-trimethyl-1,5-pentanediol, 2-methyl-2-ethyl-1,3-propanediol, 1,4-bis(hydroxyethoxy)benzene, 1,4-butanediol, and mixtures thereof.

When a polyurethaneurea is desired, the chain extender is a diamine. Examples of such diamines that may be used include, but are not limited to, hydrazine, ethylene diamine, 1,2-propanediamine, 1,3-propanediamine, 1,2-butanediamine (1,2-diaminobutane), 1,3-butanediamine (1,3-diaminobutane), 1,4-butanediamine (1,4-diaminobutane), 1,3-diamino-2,2-dimethylbutane, 4,4′-methylene-bis-cyclohexylamine, 1-amino-3,3,5-trimethyl-5-aminomethylcyclohexane, 1,6-hexanediamine, 2,2-dimethyl-1,3-diaminopropane, 2,4-diamino-1-methylcyclohexane, N-methylaminobis(3-propylamine), 2-methyl-1,5-pentanediamine, 1,5-diaminopentane, 1,4-cyclohexanediamine, 1,3-diamino-4-methylcyclohexane, 1,3-cyclohexane-diamine, 1,1-methylene-bis(4,4′-diaminohexane), 3-aminomethyl-3,5,5-trimethylcyclohexane, 1,3-pentanediamine (1,3-diaminopentane), m-xylylene diamine, and mixtures thereof. An ethylene diamine as an extender is preferred.

Optionally, a chain terminator, for example diethylamine, cyclohexylamine, n-hexylamine, or a monofunctional alcohol chain terminator such as butanol, can be used to control the molecular weight of the polymer. Additionally, a higher functional alcohol “chain brancher” such as pentaerythritol, or a trifunctional “chain brancher,” such as diethylenetriamine, may be used to control solution viscosity.

The polyurethanes and polyurethaneureas of the present invention may be used in any application where polyurethanes or polyurethaneureas of this general type are employed, but are of special benefit in fabricating articles which, in use, require high elongation, low modulus, or good low temperature properties. They are of particular benefit in fabricating spandex, elastomers, flexible and rigid foams, coatings (both solvent and water-based), dispersions, films, adhesives, and shaped articles.

As used herein and unless otherwise indicated, the term “spandex” means a manufactured fiber in which the fiber-forming substance is a long chain synthetic polymer comprised of at least 85 percent by weight of a segmented polyurethane or polyurethaneurea. Spandex is also referred to as elastane.

The spandex of the present invention can be used to make knit and woven stretch fabrics, and garments or textile articles comprising such fabrics. Stretch fabric examples include circular, flat, and warp knits, and plain, twill, and satin wovens. The term “garment,” as used herein, refers to an article of clothing such as a shirt, pants, skirt, jacket, coat, work shirt, work pants, uniform, outerwear, sportswear, swimsuit, bra, socks, and underwear, and also includes accessories such as belts, gloves, mittens, hats, hosiery, or footwear. The term “textile article,” as used herein, refers to an article comprising fabric, such as a garment, and further includes such items as sheets, pillowcases, bedspreads, quilts, blankets, comforters, comforter covers, sleeping bags, shower curtains, curtains, drapes, tablecloths, napkins, wiping cloths, dish towels, and protective coverings for upholstery or furniture.

The spandex of the present invention can be used alone or in combination with various other fibers in wovens, weft (including flat and circular) knits, warp knits, and personal hygiene apparel such as diapers. The spandex can be bare, covered, or entangled with a companion fiber such as nylon, polyester, acetate, cotton, and the like.

Fabrics comprising the spandex of the present invention may also comprise at least one fiber selected from the group consisting of protein, cellulosic, and synthetic polymer fibers, or a combination of such members. As used herein, “protein fiber” means a fiber composed of protein, including such naturally occurring animal fibers as wool, silk, mohair, cashmere, alpaca, angora, vicuna, camel, and other hair and fur fibers. As used herein, “cellulosic fiber” means a fiber produced from tree or plant materials, including for example cotton, rayon, acetate, lyocell, linen, ramie, and other vegetable fibers. As used herein, “synthetic polymer fiber” means a manufactured fiber produced from a polymer built up from chemical elements or compounds, including for example polyester, polyamide, acrylic, spandex, polyolefin, and aramid.

An effective amount of a variety of additives can also be used in the spandex of the invention, provided they do not detract from the beneficial aspects of the invention. Examples include delustrants such as titanium dioxide and stabilizers such as hydrotalcite, a mixture of huntite and hydromagnesite, barium sulfate, hindered phenols, and zinc oxide, dyes and dye enhancers, antimicrobials, antitack agents, silicone oil, hindered amine light stabilizers, UV screeners, and the like.

The spandex of the present invention or the fabric comprising it may be dyed and printed by customary dyeing and printing procedures, such as from an aqueous dye liquor by the exhaust method at temperatures between 20° C. and 130° C., by padding the material comprising the spandex with dye liquors, or by spraying the material comprising the spandex with dye liquor.

Conventional methods may be followed when using an acid dye. For example, in an exhaust dyeing method, the fabric can be introduced into an aqueous dye bath having a pH of between 3 and 9 which is then heated steadily from a temperature of approximately 20° C. to a temperature in the range of 40 to 130° C. over the course of about 10 to 80 minutes. The dye bath and fabric are then held at temperature in the range of 40 to 130° C. for from 10 to 60 minutes before cooling. Unfixed dye is then rinsed from the fabric. Stretch and recovery properties of the spandex are best maintained by minimal exposure time at temperatures above 110° C. Conventional methods may also be followed when using a disperse dye.

As used herein, the term “washfastness” means the resistance of a dyed fabric to loss of color during home or commercial laundering. Lack of washfastness can result in color loss, sometimes referred to as color bleed, by an article that is not washfast. This can result in a color change in an article which is laundered together with the article that is not washfast. Consumers generally desire fabrics and yarns to exhibit washfastness. Washfastness relates to fiber composition, fabric dyeing and finishing processes, and laundering conditions. Spandex having improved washfastness is desired for today's apparel.

The washfastness properties of the spandex may be supported and further enhanced by use of customary auxiliary chemical additives. Anionic syntans may be used to improve the wetfastness characteristics, and can also be used as retarding and blocking agents when a minimal partition of dye is required between the spandex and partner yarn. Anionic sulfonated oil is an auxiliary additive used to retard anionic dyes from spandex or partner fibers that have a stronger affinity for the dye where uniform level dyeing is required. Cationic fixing agents can be used alone or in conjunction with anionic fixing agents to support improved washfastness.

Spandex fiber can be formed from the polyurethane or polyurethaneurea polymer solution of the present invention through fiber spinning processes such as dry spinning or melt spinning. Polyurethaneureas are typically dry-spun or wet-spun when spandex is desired. In dry spinning, a polymer solution comprising a polymer and solvent is metered through spinneret orifices into a spin chamber to form a filament or filaments. Typically, the polyurethaneurea polymer is dry spun into filaments from the same solvent as was used for the polymerization reactions. Gas is passed through the chamber to evaporate the solvent to solidify the filament(s). Filaments are dry spun at a windup speed of at least 550 meters per minute. The spandex of the present invention is preferably spun at a speed in excess of 800 meters per minute. As used herein, the term “spinning speed” refers to windup speed, which is determined by and is the same as the drive roll speed. Good spinability of spandex filaments is characterized by infrequent filament breaks in the spinning cell and in the wind up. The spandex can be spun as single filaments or can be coalesced by conventional techniques into multi-filament yarns. Each filament is of textile decitex (dtex), in the range of 6 to 25 dtex per filament.

It is well known to those skilled in the art that increasing the spinning speed of a spandex composition will reduce its elongation and raise its load power compared to the same spandex spun at a lower speed. Therefore, it is common practice to slow spinning speeds in order to increase the elongation and reduce the load power of a spandex in order to increase its draftability in circular knitting and other spandex processing operations. However, lowering spinning speed reduces manufacturing productivity.

One deficiency of high ethyleneether content poly(tetramethylene-co-ethylene ether-based spandex is that the tenacity is often much lower than that of poly(tetramethylene ether)glycol-based spandex compositions. As shown in Table 1, spandex filaments based on high ethyleneether content poly(tetramethylene-co-ethyleneether)glycol (Comparison Example 3) containing 50 mole percent ethyleneether, have a tenacity of 0.5887 g/denier, whereas poly(tetramethylene ether)glycol-based spandex filaments (Comparison Example 2) have a tenacity of 1.2579 g/denier. In Example 1, the spandex filaments are based on poly(tetramethylene-co-ethyleneether)glycol containing 10.5 mole percent ethyleneether and have a tenacity of 1.2554 g/denier. Poly(tetramethylene-co-ethylene ether)glycols are less expensive to manufacture than poly(tetramethylene ether)glycol. Therefore, the present invention provides for a less expensive spandex without sacrificing tenacity.

In addition to tenacity, it is desirable to have the fiber unload power at 100% elongation as high as possible for some fabric constructions. Spandex with poly(tetramethylene-co-ethyleneether) having high ethyleneether content (Comparison Example 3) provides lower unload power at 100% elongation (0.0163 g/denier) than poly(tetramethylene ether)glycol-based spandex (Comparison Example 2, 0.0181 g/denier), thereby limiting the utility of spandex containing poly(tetramethylene-co-ethyleneether) with high ethyleneether content. The spandex of the present invention, Example 1, has identical unload power at 100% elongation (0.0181 g/denier) as poly(tetramethylene ether)glycol-based spandex and is therefore capable of being substituted for poly(tetramethylene ether)glycol-based spandex in fabric applications requiring strict retractive force parameters.

Spandexes of the present invention also demonstrate favorable set characteristics, i.e., gain in fiber length upon stretching the first five cycles. Spandexes of the present invention based on low ethyleneether containing poly(tetramethylene-co-ethyleneether)glycols have a much lower set (Example 1, 22.8%) compared with those based on high ethyleneether containing poly(tetramethylene-co-ethyleneether)glycols (Comparison Example 3, 30.0%) having the same molecular weight when spun under identical conditions. As shown in Table 1, spandexes based on low ethyleneether containing poly(tetramethylene-co-ethyleneether)glycols approach set values found in poly(tetramethylene ether)glycol-based spandex (Comparison Example 2, 20.5%). Low set is important so that after stretching, the fabric can return to its intended dimensions with a minimum of permanent distortion. Because the set of the spandex of this invention is nearly the same as that of poly(tetramethylene ether)glycol-based spandex, no redesign of fabric construction by the garment manufacturer is necessary. However, with the significantly higher set of high ethyleneether-content poly(tetramethylene-co-ethyleneether) glycol-based spandex, fabric constructions likely would have to be redesigned.

The spandex of the present invention also demonstrates certain advantages over poly(tetramethylene ether)glycol-based spandex. For example, the spandex of the present invention (Example 1) provides a higher unload power at 200% elongation (0.0311 g/denier) than poly(tetramethylene ether)glycol-based spandex (Comparison Example 2, 0.0293 g/denier). Accordingly, the garment manufacturer using the spandex of the present invention may use less material to meet the retractive force requirements for a given garment construction than is necessary with poly(tetramethylene ether)glycol-based spandex, thereby providing an economic benefit.

The spandex of the present invention also demonstrates superior load power properties, i.e., resistance to stretch. As shown in Table 1, the load power for the spandex of the present invention (Example 1) is lower on both the first cycle (0.0710 g/denier) and the fifth cycle (0.0238 g/denier) at 100% elongation compared with poly(tetramethylene ether)glycol-based spandex (Comparison Example 2) which provides a first cycle (0.0831 g/denier) and fifth cycle (0.0258 g/denier) load power at 100% elongation. Accordingly, the spandex of the present invention provides advantages for both garment manufacturers (first cycle) and consumers (fifth cycle) because of the increased draftability of the spandex, which can be used to lower spandex content or to improve comfort for the garment wearer.

The spandex of the present invention also displays a higher elongation (Example 1, 512%) than poly(tetramethylene ether)glycol-based spandex (Comparison Example 2, 479%). Higher elongation benefits the garment manufacturer because of the increased draftability of the spandex, which can be used to lower spandex content.

The practice of the present invention is demonstrated by the Examples below which are not intended to limit the scope of the invention. Physical property data for each of the Examples are displayed in Table 1.

As used herein and unless otherwise indicated, the term “DMAc” means dimethylacetamide solvent, the term “% NCO” means weight percent of the isocyanate end groups in a capped glycol, the term “MPMD” means 2-methyl-1,5-pentanediamine, the term “EDA” means 1,2-ethylenediamine, and the term “PTMEG” means poly(tetramethylene ether)glycol.

As used herein, the term “capping ratio” is defined as the molar ratio of diisocyanate to glycol, with the basis defined as 1.0 mole of glycol. Therefore, the capping ratio is typically reported as a single number, the moles of diisocyanate per one mole of glycol. For the polyurethaneureas of the present invention, the preferred molar ratio of diisocyanate to poly(tetramethylene-co-ethylene ether)glycol is about 1.2 to about 2.3. For the polyurethanes of the present invention, the preferred molar ratio of diisocyanate to poly(tetramethylene-co-ethylene ether)glycol is about 2.3 to about 17, preferably about 2.9 to about 5.6.

### Materials

THF and PTMEG (TERATHANE® 1800) are available from Invista S. à r. 1., Wilmington, Del., USA. NAFION® perfluorinated sulfonic acid resin is available from E.I. DuPont de Nemours and Company, Wilmington, Del., USA.

### Analytical Methods

Tenacity is the stress at break in the sixth stretching cycle, or in other words, the resistance of the fiber to breaking at ultimate elongation. Load power is the stress at specified elongations in the first stretching cycle, or in other words, the resistance of the fiber to being stretched to higher elongation. Unload power is the stress at specified elongations in the fifth retraction cycle, or in other words, the retractive force of the fiber at a given elongation after having been cycled to 300 percent elongation five times.

Percent Isocyanate—Percent isocyanate (% NCO) of the capped glycol blends was determined according to the method of S. Siggia, “Quantitative Organic Analysis via Functional Group”, 3rd Edition, Wiley & Sons, New York, pages 559-561 (1963) using a potentiometric titration.

Ethyleneether Content—The level of ethyleneether content in the poly(tetramethylene-co-ethyleneether)glycols of the present invention was determined from ¹H NMR measurements. The sample of poly(tetramethylene-co-ethyleneether)glycol was dissolved in a suitable NMR solvent such as CDCl₃ and the ¹H NMR spectrum obtained. The integral of the combined —OCH₂— peaks at 3.7-3.2 ppm was compared to the integral of the combined —C—CH₂CH₂—C— peaks from 1.8-1.35 ppm. The —OCH₂— peaks come from both EO-based linkages (—O—CH₂CH₂—O—) and from THF-based linkages (—O—CH₂CH₂CH₂CH₂—O—) while the —C—CH₂CH₂—C— linkages come from THF only. To find the molar fraction of ethyleneether linkages in the poly(tetramethylene-co-ethyleneether)glycol, the integral of the —C—CH₂CH₂—C— peaks was subtracted from the integral of the combined —OCH₂— peaks and then that result was divided by the integral of the —OCH₂— peaks.

Number Average Molecular Weight—The number average molecular weight of the poly(tetramethylene-co-ethyleneether)glycol was determined by the hydroxyl number method.

Strength and Elastic Properties—The strength and elastic properties of the spandex were measured in accordance with the general method of ASTM D 2731-72. An Instron tensile tester was used to determine tensile properties. Three filaments, a 2-inch (5-cm) gauge length and zero-to-300% elongation cycles were used for each of the measurements “as-is” from the windup, that is, without scouring or other treatment, after 24 hours of aging at approximately 70 OF and 65% relative humidity (±2%) in a controlled environment. The samples were cycled five times at a constant elongation rate of 50 cm per minute and then held at 300% extension for 30 seconds after the fifth extension.

Load power, the stress on spandex during initial extension, was measured on the first cycle at 100%, 200%, or 300% extension and is reported in the Table in grams per denier and designated “LP”. Unload power, the stress at an extension of 100% or 200% on the fifth unload cycle, is also reported in grams per denier; it is designated as “UP”. Percent elongation at break (“Elo”) and tenacity were measured on the sixth extension cycle using modified Instron grips to which a rubber tape was attached for reduced slippage.

Percent Set—Unless otherwise indicated, percent set was also measured on samples that had been subjected to five 0-300% elongation/relaxation cycles. Percent set (“% SET”) was calculated as:
% SET=—100(Lf−Lo)/Lo
wherein L₀ and L_{f} are the filament (yarn) length, when held straight without tension, before and after the five elongation/relaxation cycles, respectively.

Circular Knit (CK) Draft—In knitting, the spandex stretches (drafts) when it is delivered from the supply package to the carrier plate and in turn to the knit stitch due to the difference between the stitch use rate and the feed rate from the spandex supply package. The ratio of the hard yarn supply rate (meters/min) to the spandex supply rate is normally 2.5 to 4 times (2.5× to 4×) greater, and is known as the machine draft, “MD.” This corresponds to spandex elongation of 150% to 300%, or more. As used herein, the term “hard yarn” refers to relatively inelastic yarn, such as polyester, cotton, nylon, rayon, acetate, or wool.

The total draft of the spandex yarn is a product of the machine draft (MD) and the package draft (PD), which is the amount that the spandex yarn is already stretched on the supply package. For a given denier (or decitex), the spandex content in a fabric is inversely proportional to the total draft; the higher the total draft, the lower the spandex content. PR is a measured property called “Percent Package Relaxation” and is defined as 100 * (length of yarn on the package−length of relaxed yarn)/(length of yarn on the package). PR typically measures 5 to 15 for the spandex used in circular knit, elastic, single jersey fabrics. Using the measured PR, package draft (PD) is defined as 1/(1-PR/100). Therefore, the total draft (TD) may also be calculated as MD/(1-PR/100). A yarn with 4× machine draft and 5% PR would have a total draft of 4.21×, while a yarn with machine draft of 4× and 15% PR would have a total draft of 4.71×.

For economic reasons, circular knitters will often try to use the minimum spandex content consistent with adequate fabric properties and uniformity. As explained above, increasing spandex draft is a way to reduce content. The main factor that limits draft is the percent elongation to break, so a yarn with high percent elongation to break is the most important factor. Other factors, such as tenacity at break, friction, yarn tackiness, denier uniformity, and defects in yarn can reduce the practical achievable draft. Knitters will provide a safety margin for these limiting factors by reducing draft from the ultimate draft (measured percent elongation at break). They typically determine this “sustainable draft” by increasing draft until knitting breaks reach an unacceptable level, such as 5 breaks per 1,000 revolutions of the knitting machine, then backing off until acceptable performance is regained.

Tension in knitting needles can also be a limiting factor for draft. The feed tension in the spandex yarn is directly related to the total draft of the spandex yarn. It is also a function of the inherent modulus (load power) of the spandex yarn. In order to maintain acceptably low tension in knitting at high draft, it is advantageous for the spandex to have a low modulus (load power). The ideal yarn for high draftability would therefore have high percent elongation to break, low modulus (load power), adequately high tenacity, low friction and tack, uniform denier, and a low level of defects.

Because of its stress-strain properties, spandex yarn drafts (draws) more as the tension applied to the spandex increases; conversely, the more that the spandex is drafted, the higher the tension in the yarn. A typical spandex yarn path in a circular knitting machine is as follows. The spandex yarn is metered from the supply package, over or through a broken end detector, over one or more change-of-direction rolls, and then to the carrier plate, which guides the spandex to the knitting needles and into the stitch. There is a build-up of tension in the spandex yarn as it passes from the supply package and over each device or roller, due to frictional forces imparted by each device or roller that touches the spandex. The total draft of the spandex at the stitch is therefore related to the sum of the tensions throughout the spandex path.

Residual DMAc in Spandex -The percent DMAc remaining in the spandex samples was determined by using a Duratech DMAc analyzer. A known amount of perclene was used to extract the DMAc out of a known weight of spandex. The amount of DMAc in the perclene was then quantified by measuring the UV absorption of the DMAc and comparing that value to a standardization curve.

Hot-Wet Creep (HWC)—Hot-wet creep is determined by measuring an original length, L₀, of a yarn, stretching it to one-and-a-half times its original length (1.5 L₀), immersing it in its stretched condition for 30 minutes in a water bath maintained at temperature in the range of 97 to 100° C., removing it from the bath, releasing the tension and allowing the sample to relax at room temperature for a minimum of 60 minutes before measuring the final length, L_{f}. The percent hot-wet creep is calculated from the formula:
% HWC=100×[(L_{f}−L₀)/L₀]
Fibers with low % HWC provide superior performance in hot-wet finishing operations, such as dyeing.

### EXAMPLES

### Example 1

### (Low EO-Containing Spandex)

A sample of poly(tetramethylene-co-ethyleneether)glycol with 10.5 mole percent ethyleneether content and 1774 Daltons molecular weight was prepared by blending two samples. One of the samples had 11.3 mole percent ethyleneether content and 1600 Daltons molecular weight while the other had 10 mole percent ethyleneether content and 1997 Daltons molecular weight. Both of these samples were prepared by passing a solution of THF, ethylene oxide, and water through a fixed bed of acidic clay catalyst, followed by distilling off the unreacted THF and cyclic ether by-products.

The blended poly(tetramethylene-co-ethyleneether)glycol was capped with 1-isocyanato-4-[(4-isocyanato-phenyl)methyl]benzene at 90° C. for 90 minutes to give a 2.62 % NCO prepolymer. This capped glycol was then diluted with DMAc solvent, chain extended with a mixture of EDA and MPMD (90/10 ratio), and chain terminated with diethylamine to give a spandex product similar in composition to a commercial spandex. The amount of DMAc used was such that the final spinning solution had 31 wt % polyurethane in it, based on total solution weight. The spinning solution was dry-spun into a column provided with 415° C. dry nitrogen, coalesced, passed around a godet roll and wound up at 869 m/min. Spinnability was good. Fiber properties are presented in Table 1.

### Comparison Example 2

### PTMEG-based Spandex

A sample of PTMEG with 1 800s Dalton molecular weight was capped with 1-isocyanato-4-[(4-isocyanato-phenyl)methyl]benzene to a 2.62 % NCO, chain extended with EDA and MPMD (90/10 ratio), chain terminated with diethylamine, and spun into spandex fibers according to the procedure in Example 1.

### Comparison Example 3

### High EO Spandex

A sample of poly(tetramethylene-co-ethyleneether)glycol having 2000 Dalton molecular weight and 50 mole percent ethyleneether content was capped with 1-isocyanato-4-[(4-isocyanato-phenyl)methyl]benzene at 90° C. for 120 minutes using 100 ppm of a mineral acid as a capping catalyst. The capped glycol was then chain extended with EDA and MPMD (90/10 ratio), chain terminated with diethylamine, and spun into spandex fibers according to the procedure in Example 1.

TABLE 1

| | | Comparison | Comparison |
|---|---|---|---|
| SPANDEX PROPERTY* | Example 1 | Example 2 | Example 3 |
| Glycol MW (Daltons) | 1774 | 1800 | 2000 |
| Mole % ethyleneether in | 10.5 | 0 | 50 |
| glycol | | | |
| Capping ratio | 1.68 | 1.69 | 1.75 |
| Extender (90/10 ratio) | EDA/MPMD | EDA/MPMD | EDA/MPMD |
| Tenacity | 1.2554 | 1.2579 | 0.5887 |
| (g/denier) | | | |
| Unload power at 100% | 0.0181 | 0.0180 | 0.0163 |
| elongation - 5th cycle | | | |
| (g/denier) | | | |
| Unload power at 200% | 0.0311 | 0.0293 | 0.0347 |
| elongation - 5th cycle | | | |
| (g/denier) | | | |
| Load power at 100% | 0.0710 | 0.0831 | 0.0567 |
| elongation - 1st cycle | | | |
| (g/denier) | | | |
| Load power at 200% | 0.1516 | 0.1826 | 0.1003 |
| elongation - 1st cycle | | | |
| (g/denier) | | | |
| Load power at 100% | 0.0238 | 0.0258 | 0.0190 |
| elongation - 5th cycle | | | |
| (g/denier) | | | |
| Load power at 200% | 0.0521 | 0.0556 | 0.0420 |
| elongation - 5th cycle | | | |
| (g/denier) | | | |
| Elongation (%) | 512 | 479 | 619 |
| Set (%) | 22.8 | 20.5 | 30.0 |

*All data was generated after 0-300% elongation cycling. All spandex fiber samples were spun under conditions that dried all of the yarns to about the same residual solvent level.

The applicants have observed that as the level of ethyleneether in the poly(tetramethylene-co-ethyleneether)glycol rises above about 16 mole percent, the melting point of the poly(tetramethylene-co-ethyleneether)glycol rapidly decreases. In parallel with this observation, several of the spandex physical properties, based on these poly(tetramethylene-co-ethyleneether)glycols, rapidly change as the ethyleneether content rises. The stress-strain curve of the spandex no longer resembles the curve of PTMEG-based spandex. Furthermore, applicants have discovered that when the amount of ethyleneether in the poly(tetramethylene-co-ethyleneether)glycol is kept at or below approximately 16 mole percent, the stress-strain curve of the product spandex is nearly identical to that of PTMEG-based spandex. Applicants have found that when the ethyleneether content in a poly(tetramethylene-co-ethyleneether)glycol is at or below about 16 mole percent, the poly(tetramethylene-co-ethyleneether)glycols provide a spandex with properties approaching those based on PTMEG. At these lower ethyleneether levels both a cost savings and a performance like PTMEG-based spandex may be obtained.

An advantage of the present invention lies in the fact that poly(tetramethylene-co-ethyleneether)glycols with less than 16 mole percent ethyleneether are less expensive to manufacture than PTMEG. Therefore, the spandex (or polyurethanes) based on the poly(tetramethylene-co-ethyleneether)glycols has a lower raw material cost. Importantly, however, the poly(tetramethylene-co-ethyleneether)glycol-based spandex products continue to provide the same performance properties as the currently marketed PTMEG-based spandex products.

We prefer the poly(tetramethylene-co-ethyleneether)glycols partly due to a lower cost of ethylene oxide versus tetrahydrofuran, and partly due to a less costly glycol manufacturing process. PTMEG (e.g., TERATHANE 1800) is most commonly made using a process employing a catalyst and a promoter system (acetic anhydride) that requires additional processing steps after polymerization to remove the acetate end-groups to produce the product glycol. The poly(tetramethylene-co-ethyleneether)glycol process of the present invention, however, uses ethylene oxide to initiate the polymerization and results directly in product glycol.

Using poly(tetramethylene-co-ethyleneether)glycols with higher amounts of ethyleneether provides a spandex (or polyurethane) with markedly different physical properties than those based on PTMEG having the same molecular weight. Some of the spandex properties such as elongation, load power, retractive force at 200% or greater elongation (TM2), and low temperature performance improve, but some properties worsen (e.g., resistance to breaking (tenacity)).

The invention has been described in detail with reference to preferred embodiments thereof. However, it will be appreciated that those skilled in the art, upon consideration of this disclosure, may make modifications and improvements within the spirit and scope of the invention.

What is claimed is:

1. A polyurethaneurea comprising the reaction product of:
(a) a poly(tetramethylene-co-ethyleneether)glycol comprising constituent units derived by copolymerizing tetrahydrofuran and ethylene oxide wherein the portion of the units derived from ethylene oxide is present in the poly(tetramethylene-co-ethyleneether)glycol at less than about 15 mole percent;
(b) at least one diisocyanate; and
(c) at least one diamine chain extender.

2. The polyurethaneurea of claim 1 wherein the portion of the units derived from ethylene oxide is present in the poly(tetramethylene-co-ethyleneether)glycol at between about 5 and less than about 15 mole percent.

3. The polyurethaneurea of claim 1 wherein the portion of the units derived from ethylene oxide is present in the poly(tetramethylene-co-ethyleneether)glycol at between about 10 and less than about 15 mole percent.

4. Spandex comprising a polyurethaneurea reaction product of claim 1.

5. Spandex comprising a polyurethaneurea reaction product of claim 2.

6. Spandex comprising a polyurethaneurea reaction product of claim 3.

7. The spandex of claim 4 wherein said poly(tetramethylene-co-ethyleneether)glycol has a molecular weight between about 650 Dalton and about 4000 Dalton.

8. The spandex of claim 4 wherein said polyurethaneurea has a molar ratio of diisocyanate to poly(tetramethylene-co-ethyleneether)glycol between about 1.2 and about 2.3.

9. The spandex of claim 4 wherein the diisocyanate is selected from the group consisting of 1-isocyanato-4-[(4-isocyanato-phenyl)methyl]benzene, 1-isocyanato-2-[(4-isocyanato-phenyl)methyl]benzene, and mixtures thereof.

10. The spandex of claim 4 wherein the diamine chain extender is selected from the group consisting of ethylene diamine, 2-methylpentanediamine, and 1,2-propanediamine, and mixtures thereof.

11. The spandex of claim 4 having a tenacity equal to or greater than 1.0 gram per denier.

12. The spandex of claim 4 having an unload power at 100 percent elongation equal to or greater than about 0.016 grams per denier.

13. The spandex of claim 11 wherein the spandex is spun at a speed in excess of about 800 meters per minute.

14. The spandex of claim 12 wherein the spandex is spun at a speed in excess of about 800 meters per minute

15. A polyurethane comprising a reaction product of:
(a) a poly(tetramethylene-co-ethyleneether)glycol comprising constituent units derived by copolymerizing tetrahydrofuran and ethylene oxide wherein the portion of the units derived from ethylene oxide is present in the poly(tetramethylene-co-ethyleneether)glycol at less than about 15 mole percent;
(b) at least one diisocyanate; and
(c) at least one diol chain extender.

16. Spandex comprising a polyurethane reaction product of claim 15.

17. A process for preparing spandex comprising:
(a) contacting a poly(tetramethylene-co-ethyleneether)glycol comprising constituent units derived by copolymerizing tetrahydrofuran and ethylene oxide wherein the portion of the units derived from ethylene oxide is present in the poly(tetramethylene-co-ethyleneether)glycol at less than about 15 mole percent with at least one diisocyanate to form a capped glycol;
(b) optionally adding a solvent to the product of (a);
(c) contacting the product of (b) with at least one diamine or diol chain extender; and
(d) spinning the product of (c) to form spandex.

18. The process of claim 17 wherein the diisocyanate is selected from the group consisting of 1-isocyanato-4-[(4-isocyanato-phenyl)methyl]benzene, 1-isocyanato-2-[(4-isocyanato-phenyl)methyl]benzene, and mixtures thereof and wherein the molar ratio of diisocyanate to poly(tetramethylene-co-ethyleneether)glycol is about 1.2 to about 2.3.

19. The process of claim 17 wherein the diamine chain extender is selected from the group consisting of ethylene diamine, 2-methylpentanediamine, and 1,2-propanediamine, or mixtures thereof.

20. The process of claim 17 wherein the spinning to form spandex is dry-spinning and the poly(tetramethylene-co-ethyleneether)glycol has a molecular weight of about 650 Dalton to about 4000 Dalton.

21. The process of claim 20 wherein the spandex is spun at a speed in excess of about 800 meters per minute.

22. A fabric comprising the spandex of claim 4.

23. A fabric comprising the spandex of claim 15.

24. A garment or textile article comprising the fabric of claim 22.

25. A garment or textile article comprising the fabric of claim 23.

26. A dispersion, a coating, a film, an adhesive, an elastomer, or a shaped article comprising the polyurethaneurea of claim 1.

27. A dispersion, a coating, a film, an adhesive, an elastomer, or a shaped article comprising the polyurethane of claim 15.
